(19) United States
(12) Patent Application Publication
(10) Pub. No.: US 2010/0024294 A1
(43) Pub. Date: Feb. 4, 2010

(54) PLANT ACCLIMATIZING ENCLOSURE

(75) Inventor: Malcolm Glen Kertz, El Paso, TX (US)

Correspondence Address: CONLEY ROSE, P.C.;David A. Rose, P. O. BOX 3267, HOUSTON, TX, 77253-3267, US

(73) Assignee: CONLEY ROSE, P. C., Houston, TX (US)

(21) Appl. No.: 12/510,643

(22) Filed: Jul. 28, 2009

Related U.S. Application Data
(60) Provisional application No. 61/084,308, filed on Jul. 29, 2008.

(51) Int. Cl. A01G 13/02

(52) U.S. Cl. 47/29.1; 47/20.1; 47/29.5; 47/58.1 R

(57) ABSTRACT

An enclosure for acclimatizing a micro-propagated plantlet includes a sealed growing chamber for the plantlet. The enclosure has a closable opening for providing nutrients to the plantlet and a humidity control to selectively reduce the humidity within the chamber over time to acclimatize the plantlet.

### CROSS-REFERENCE TO RELATED APPLICATIONS

This application claims priority to U.S. Provisional Patent Application No. 61/084,308 filed on Jul. 29, 2008 and titled “Plant Acclimatizing Enclosure,” incorporated herein by reference.

### STATEMENT REGARDING FEDERALLY SPONSORED RESEARCH OR DEVELOPMENT

Not applicable.

### BACKGROUND

1. Field of the Invention

This invention relates generally to the field of growing plants. More specifically, the invention relates to a method of acclimatizing plants to the environment.

2. Background of the Invention

Micropropagation is the process of growing a plurality of plants from a small portion of plant tissue. In practice, it can be conducted using a single cell or small portion of the plant to produce many genetically identical plants. Additionally, rather than producing seeds, micropropagation results in viable, growing plantlets. These plantlets typically are more robust compared to seed grown counterparts leading to higher growth rates, and faster seed or fruit production.

The process of micropropagation is a multi-step method. First, the collection of tissue, called explants, is required from a donor or parent plant. The tissue is placed into a sterile growth medium with necessary biomaterials, hormones and nutrients to induce accelerated growth. As the tissue growth leads to differentiated cells developing into the separate structures of the plant, additional explants may be taken. These additional explants from previously cultured tissue are part of a multiplication step, creating many additional plantlets.

As the plantlets mature, they require preparation for transplant into soil for conventional growth. The sterile, ideal conditions during culturing need to gradually be changed into real world conditions. This process is called hardening, and it involves a gradual change in the humidity and light conditions around the plantlet. If the process of hardening is done incorrectly, the plantlets will die quickly once transplanted into conventional potting soil mixtures. The complexity of regulating humidity and light conditions for growing plantlets is a reason micropropagation is not commercially viable for the enthusiast or casual home gardener.

Consequently, there is a need for an apparatus and method of controlling humidity to harden micropropagated plantlets for transplantation into soil.

### BRIEF SUMMARY

A container for growing and hardening plantlets includes a cover and a base. The cover includes a translucent plastic lid fitted to the base that has one or more sealable openings therein, each having a removable sealing member. The cover affixes to the base in an air and water tight manner, creating a sealed growing chamber having a controlled environment.

The container can be used to harden plantlets by removing a sealing member from a sealable opening to alter the humidity within the growing chamber. The humidity within the growing chamber is controllable by adding liquid nutrients through an inlet in the container and selectively removing one or more sealing members from the one or more sealable openings in the cover.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a conceptual schematic of an acclimatizing container;

FIG. 2 illustrates side perspective view, of an acclimatizing container;

FIG. 3 illustrates a top view of the base of an acclimatizing container shown in FIG. 2;

FIG. 4 illustrates a top view of the cover of an acclimatizing container shown in FIG. 2;

FIG. 5 illustrates a side cross-sectional view of an acclimatizing container of FIG. 2;

FIG. 6 illustrates an alternative configuration of an acclimatizing container;

FIG. 7 illustrates a miniaturized configuration of an acclimatizing container; and

FIG. 8 illustrates an enlarged configuration of an acclimatizing container.

### DETAILED DESCRIPTION OF THE PREFERRED EMBODIMENTS

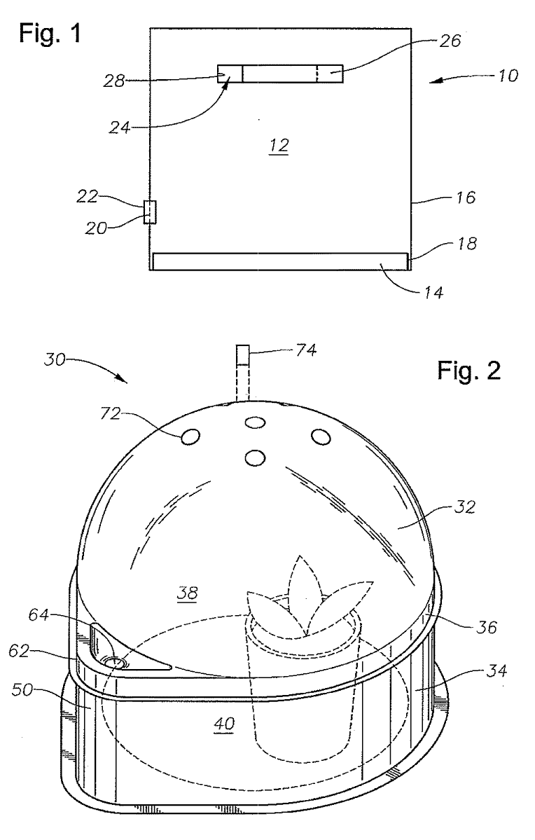

Referring initially to FIG. 1, there is shown a plant acclimatizing enclosure 10 forming a growing chamber 12 for housing and growing a plantlet. The enclosure 10 includes an ingress/egress means for accessing the chamber 12 of the enclosure 10 for the placement and removal of a plantlet. The ingress/egress means may be any means for accessing the chamber 12 such as a door or disassembly means for disassembling the enclosure 10. One such ingress/egress means is shown in FIG. 1 as a two piece enclosure. In an embodiment, the enclosure 10 includes a base member 14 and a hood 16 that is sized to fit a peripheral lip 18 of hood 16 onto the periphery of base member 14. A closable access means may be formed in either the base member 14 or hood 16 for the depositing of nutrients for the plantlet inside the chamber 12. In an embodiment, the hood 16 includes an opening 20 that is selectively closable by a closure member 22. The enclosure 10 also includes a humidity adjustment means. In an embodiment, the humidity adjustment means may include an adjustable opening 24 in the hood 16. The adjustable opening may include an aperture 28 in hood 16 having a sliding closure member 26 reciprocably disposed on hood 16 with selected positions along opening 28 for the adjustment of opening 24. The hood 16 is made of a translucent material that allows the passage of light for the growth of the plantlet inside chamber 12.

In operation, a plantlet is placed on base member 14 and hood 16 is placed over the plantlet and then lip 18 over the base member 14 to form chamber 12. Nutrients are placed through opening 20 into chamber 12. The adjustable opening 24 initially has a minimal size to maintain a high humidity within the chamber 12. Light passes through the hood 16 to the plantlet. The opening 24 is increased over time to reduce the humidity within chamber 12 to harden the plantlet.

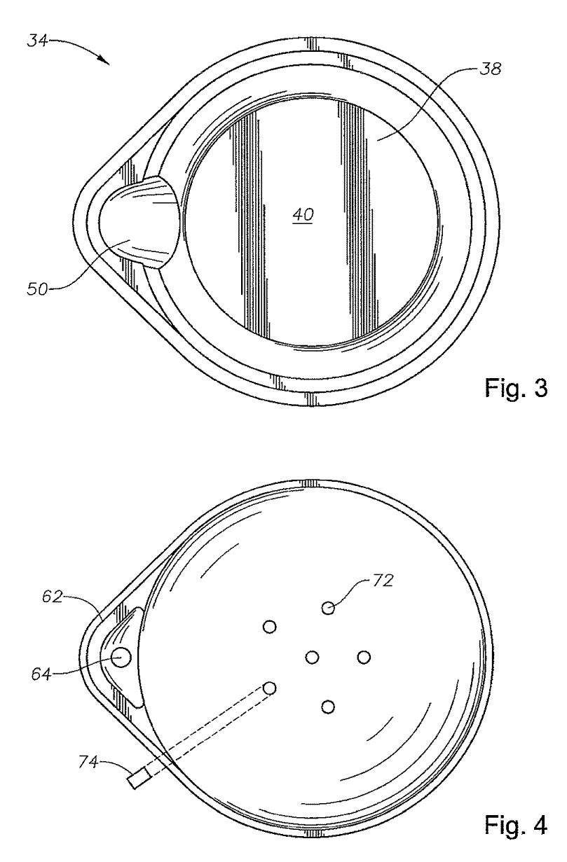

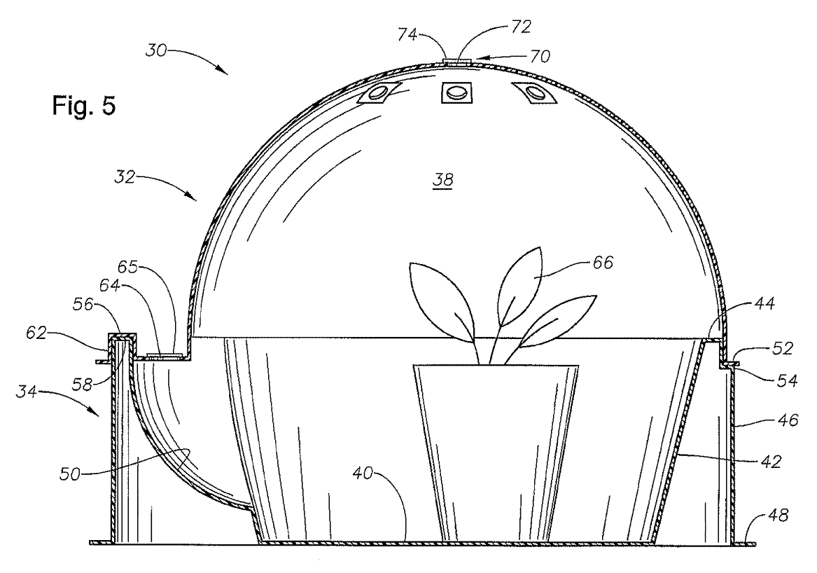

Referring now to FIGS. 2 and 5, there is illustrated another embodiment of a plant acclimatizing enclosure or container 30. The acclimatizing container 30 is comprised of a cover 32 and a base 34. Cover 32 reversibly couples to base 34 creating a water and gas impermeable barrier at interface 52. The coupling of the cover 32 and the base 34 creates an internal controlled environment, or growth chamber 38 within the acclimatizing container 30. The acclimatizing container 30 may comprise any shape without limitation such as square, rectangular, oval or polygonal, largely dependent upon the size and number of plantlets to be placed within the container. In embodiments the volume of the growth chamber 38 is between about 250 ml and about 2000 ml (2 liters); preferably between about 500 ml and about 2000 ml (2 liters); and most preferably between about 750 ml and about 1500 ml (1.5 liters).

Referring now to FIGS. 2, 3 and 5, the base 34 has a generally trapezoidal cross-section with bottom 40 providing a generally planar support for growing and hardening plantlets and an upwardly and outwardly tapered conical side 42. In an embodiment, the upper periphery of trapezoidal side 42 has an radially extending flange portion 44 integral with a generally cylindrical support 46 having an outwardly projecting support flange 48 at its lower periphery. Inlet 50 may be a spout formed in one portion of trapezoidal side 42 for the introduction of liquids and nutrients into the growing chamber 38. In certain embodiments, the inlet 50 and growing chamber 38 are contiguous. Alternatively, the inlet 50 may protrude from base 34.

Additionally, the base 34 includes an interface 52, such as a lip 54 disposed about the upper perimeter of the base 34, for coupling to cover 32. The interface 52 may be a gasket, an interference tab or a deformable connection. Alternatively, a recessed area 56 on the cover 32 may interact with a protuberance 58 from the base 34 or vice versa. The interface 52 is a mechanism configured such that the cover 32 is disposed on the base 34 to create a water and gas tight seal.

Referring now to FIGS. 3 and 5, the cover 32 is constructed of translucent polymers or plastics that are impermeable to gases and water but allows the passage of light. The cover 32 can act to diffract or absorb light. Examples of suitable materials include, but are not limited to, polyethylene, polypropylene, acrylonitrile butadiene styrene, acrylic or combinations thereof. The cover 32 and base 34 are dimensioned so as to provide a tight fit at interface 52. The material is preferably resilient or elastic, such that when positioned over the interface 52 on the base 34, there is an interference fit and the material forms a tight seal, coupling base 34 and cover 32.

Cover 32 further includes a radially extending cover member 62 dimensioned to cover inlet 50. Cover member 62 may include a sealable opening 64 for the addition of liquids and nutrients to the growing chamber 38. The sealable opening 64 has a removable closure member 65 allowing selective access to chamber 38. The closure member 65 may include sealing tape that will allow opening 64 to be opened and closed as needed to access chamber 38. The cover member 62 and closure member 65 prevent contaminants from entering the chamber 38 through the inlet 50. Alternatively, closure member 65 may comprise a flap, hinged member, lid or other member that will allow access to the growing chamber 38. Further, closure member 65 may comprise a rotatable or slidable member.

In embodiments, inlet 50 provides a fluid connection with the interior of chamber 38 for adding liquids, such as water, and nutrients, preferably liquid nutrients, to the plantlet 66. Supplemental nutrients, chemicals, hormones, water or combinations thereof are used for hardening the plantlets within the growing chamber 38. The inlet 50 with sealable and closable inlet opening 64 allows the addition of these without significant disturbances to the internal atmosphere of chamber 38.

The acclimatizing container 30 further includes a humidity control means 70. In an embodiment, the humidity control means 70 includes at least one sealable opening 72 that is reversibly sealed by a sealing member 74. In certain embodiments, the at least one sealable opening is disposed near the top of the cover 32 to facilitate water vapor escaping the growing chamber 38. In preferred embodiments the cover 32 has a plurality of openings 72 each sealed by a sealing member 74. The number and size of the sealable openings 72 and sealing members 74 are dependent upon the humidity phases for the particular plantlet 66. In certain instances the sealable openings 72 are circular holes in the cover 32. The sealable openings may have a diameter of between about 2 mm and about 10 mm, in the cover 32. The sealable openings may have a diameter of between about 5 mm and about 20 mm; preferably between about 5 mm and about 15 mm; and most preferably between about 7.5 mm and about 15 mm.

Sealing member 74 is removable from sealable openings 72 such that gases and liquid may be introduced to the growing chamber 38. The sealing member 74, functions to prevent or impede the exchange of gases or water when inserted into, over or otherwise sealing the openings 72. The sealing member 74 may be made of a flexible material such as silicon, rubber, urethane or other elastic materials as known to one skilled in the art. Alternatively sealing member 74 is a strip of adhesive material to cover the openings 72. Further alternate embodiments envisioned include a sealing member 74 comprises a portion of the cover, or sealing member 74 comprises a moveable material and/or structure coupled to the cover 32. In certain instances, the sealing member 74 is gas impermeable. In alternate instances the material of the sealing member 74 is gas permeable.

The process of hardening a plantlet resultant from micropropagation requires a gradual acclimatization to the humidity and light levels in the environment. Removal of a sealing member 74 from one or more openings 72 in the cover 32 at predetermined intervals will gradually alter the gas exchange rates between the environment in the chamber 38 and the ambient environment around the container 30. The resulting exchange of gases, including water vapor, will gradually acclimatize the plantlets.

In embodiments comprising multiple sealing members 74, with all sealing members 74 in place, the humidity within the growth chamber 38 can be maintained at between about 90% and about 95%. With one sealing member 74 removed from an opening 72 of the cover 32, the humidity can be maintained at between about 80% and about 92%; removing two sealing members 74 from two openings 72 results in a humidity level of between about 75% and about 83%. Further and subsequent removal of a sealing member 74 from an opening 72 in the cover 32 results in a humidity decrease of between about 5% and about 15% in each instance. These humidity levels are exemplary only and are partially dependent on geographical-atmospheric humidity as understood by one skilled in the art. In certain embodiments, each sealing member 74 should be removed between about 2 days and about 10 days apart to gradually acclimate the plantlet. The duration between removals of sealing member 74 is dependent on the species of plantlet and the geographical-atmospheric conditions.

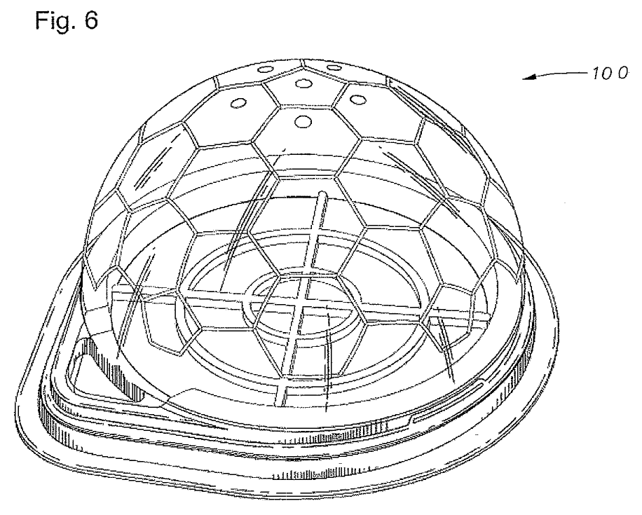

FIG. 6 illustrates a representative sphere 100 embodiment of enclosure 10. The sphere 100 is configured for acclimatizing at least one small plantlet. For example, sphere 100 would be useful for acclimatizing propagated herbs, vegetables, ivies, and the like without limitation. Sphere 100 is generally configured for placement on any suitable surface, for instance a table or countertop.

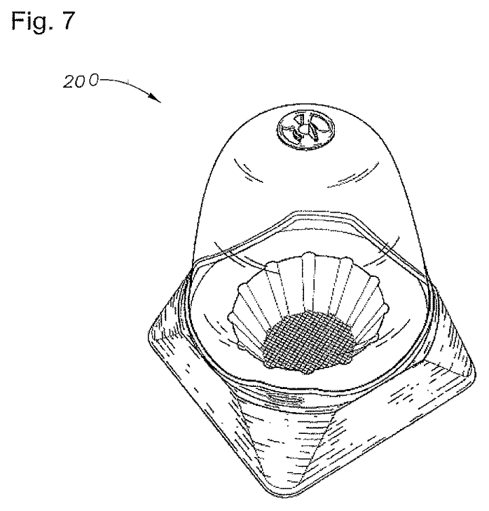

FIG. 7 illustrates a representative dome 200 embodiment of the enclosure 10. Dome 200 may be generally configured for acclimatizing an individual plantlet. Further dome 200 may be configured for acclimatizing a fast growing plant species. For example, dome 200 would be useful for acclimatizing a propagated flower, fern, herb, or vegetable plantlet without limitation. Dome 200 may be configured to fit on a windowsill, bookshelf, or end table.

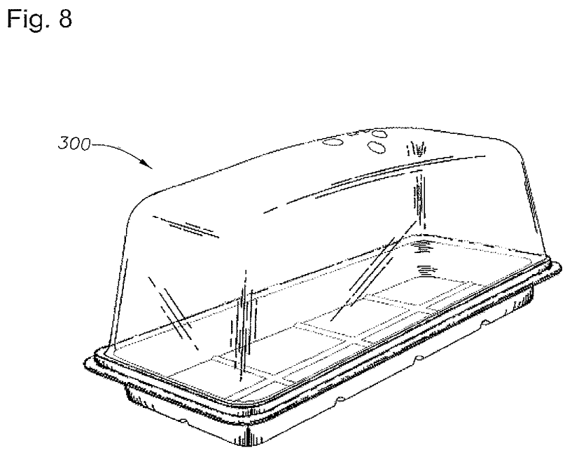

FIG. 8 illustrates a representative box 300 embodiment of enclosure 10. Box 300 may be generally configured for acclimatizing a plurality of plantlets. For instance, box 300 may contain any number of plantlets for acclimatization. In certain embodiments, box 300 may be configured for placement on a ledge, windowsill, bookshelf, or other elongate surface. Box 300 may comprise a window box or the like without limitation.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

We claim:

1. An apparatus for acclimatizing a plantlet, the apparatus comprising:
an enclosure forming a sealed growing chamber for the plantlet;
a closable opening in the enclosure; and
a humidity control on the enclosure to periodically reduce the humidity within the chamber to acclimatize the plantlet.

2. A container for hardening plantlets, the container comprising:
a cover reversibly coupled to a base, the cover and base forming a sealed growing chamber; and
the cover being of a translucent material and including at least one sealable opening, the sealable opening being reversibly sealed by at least one sealing member.

3. The container of claim 2 wherein the cover is made of a translucent plastic.

4. The container of claim 2 wherein the cover is impermeable to gases.

5. The container of claim 2 wherein the cover is impermeable to water.

6. The container of claim 2 wherein the at least one sealable opening is located on the cover.

7. The container of claim 2 wherein the at least one sealing member, seals the at least one opening located on the cover.

8. The container of claim 7 wherein the at least sealing member is impermeable to water.

9. The container of claim 7 wherein the removal of the at least one sealing member from is configured for permitting gas exchange between the chamber and the environment.

10. The container of claim 2 wherein the base is comprised of opaque plastic.

11. The container of claim 2 wherein the base is impermeable to gases.

12. The container of claim 2 wherein the base is impermeable to water.

13. The container of claim 2 wherein the coupling between the cover and the base is configured to form a gas tight seal.

14. The container of claim 2 wherein the coupling between the cover and the base is configured to form a water tight seal.

15. A method for hardening a plantlet in a container, the method comprising:
placing the plantlet in a growth media with water in the container;
sealing the container;
removing at least one sealing member from an opening in the container;
removing a closure member from a nutrient opening in the container;
adding liquid nutrients through the nutrient opening in the container;
replacing the closure member in the nutrient opening;
removing an additional sealing member from another opening in the container at a selected interval; and
repeating the steps after the sealing step until the plantlet has acclimatized.

16. The method of claim 15 wherein sealing the container comprises coupling an interference fit disposed on the container.

17. The method of claim 15, comprising opening the container to ambient conditions after the plant has been acclimatized

18. The method of claim 15, further comprising regulating humidity in the container by:
sealing the container by coupling a cover and a base;
removing at least one sealing member from a nutrient opening in the cover;
adding liquid nutrients through the nutrient opening in the cover;
closing the nutrient opening in the cover;
removing at least one sealing member from a humidity opening in the cover; and
repeating the removing of additional humidity openings to reduce the humidity in the container.

19. The method of claim 16 wherein sealing the container comprises forming an interference fit.

20. The method of claim 16, wherein removing at least one sealing member comprises reversibly detaching a sealing member from the cover.
